(19) United States
(12) Patent Application Publication
(10) Pub. No.: US 2013/0235451 A1
(43) Pub. Date: Sep. 12, 2013

(54) LENS ARRAY, IMAGE FORMING DEVICE AND METHOD FOR MANUFACTURING LENS ARRAY

(71) Applicant: TOSHIBA TEC KABUSHIKI KAISHA, Tokyo (JP)

(72) Inventors: Atsushi KUBOTA, Shizuoka (JP); Ryozo AKIYAMA, Shizuoka (JP)

(73) Assignee: TOSHIBA TEC KABUSHIKI KAISHA, Tokyo (JP)

(21) Appl. No.: 13/786,288

(22) Filed: Mar. 5, 2013

(30) Foreign Application Priority Data
Mar. 9, 2012 (JP) 2012-053609

(51) Int. Cl. G02B 3/00

(52) U.S. Cl. CPC G02B 3/005
USPC 359/355; 427/558

(57) ABSTRACT

According to one embodiment, a lens array of this embodiment is equipped with a plurality of lenses formed on a substrate, and light-blocking films including a plurality of layers, are formed by using an ultraviolet curable ink deposited between the lenses.

### CROSS-REFERENCE TO RELATED APPLICATION

This application is based upon and claims the benefit of priority from Japanese Patent Application No. 2012-053609, filed Mar. 9, 2012; the entire contents of which are incorporated herein by reference.

### FIELD

Embodiments described herein relate generally to a lens array to which a light-blocking film is provided between a plurality of lenses, an image forming device, and a method for manufacturing a lens array.

### BACKGROUND

A light-blocking film for blocking stray light has been provided to many lens arrays used in image forming devices such as printers, copiers, multifunction peripherals (MFP), fax machines, and scanners; or liquid crystal display devices, solid-state imaging devices, multiple image transfer by optical interconnection devices, confocal laser microscopes, or, in the field of optical communications, optical disks, image displays, image transmission and coupling devices, optical metrology devices, optical sensing devices, optical processing devices, and the like.

For a lens array having a light-blocking film formed thereon using ultraviolet curable ink, during curing, the ultraviolet curable ink itself blocks the ultraviolet light, attenuating the ultraviolet light in the depth direction of the ultraviolet curable ink, creating a possibility that the ultraviolet curable ink cannot be sufficiently cured through the depth of the light blocking layer so formed.

### DESCRIPTION OF THE DRAWINGS

FIG. 1 is a schematic diagram illustrating an image forming device according to a first embodiment.

FIG. 2 is a schematic diagram illustrating a black (K) image forming device according to the first embodiment.

FIG. 3 is a schematic diagram illustrating an image sensor according to the first embodiment.

FIG. 4 is a schematic top view illustrating a lens array according to the first embodiment.

FIG. 5 is a schematic illustration of the lens array according to the first embodiment taken across line d-d′ of FIG. 4.

FIG. 6 is a schematic illustration showing an enlarged view of a portion of the lens array in FIG. 5 according to the first embodiment.

FIG. 7 is a schematic illustration showing a light-blocking film forming device according to the first embodiment.

FIG. 8 is a graph illustrating light-blocking characteristics of the light-blocking film according to the first embodiment.

FIG. 9 is a schematic illustration showing fixation of a substrate to a conveying table in a method for manufacturing the light-blocking film according to the first embodiment.

FIG. 10 is a schematic illustration showing ejection of an ultraviolet curable ink in the method for manufacturing the light-blocking film according to the first embodiment.

FIG. 11 is a schematic illustration showing ultraviolet irradiation in the method for manufacturing the light-blocking film according to the first embodiment.

FIG. 12 is a schematic illustration showing completion of formation of a first light-blocking film and a second light-blocking film in the method for manufacturing the light-blocking film according to the first embodiment.

FIG. 13 is a schematic illustration showing an enlarged view of a portion of the lens array in an alternative example of the first embodiment.

FIG. 14 is a schematic illustration showing an enlarged view of a portion of the lens array in another alternative example of the first embodiment.

FIG. 15 is a schematic illustration showing a state in which two layers of light-blocking films are provided on one side of a lens array according to a second embodiment.

FIG. 16 is a schematic illustration showing a state in which two layers of light-blocking films are provided on both sides of a lens array according to the second embodiment.

FIG. 17 is a schematic illustration showing a state in which two layers of light-blocking films are provided on one side of the lens array according to a third embodiment.

FIG. 18 is a schematic illustration showing a state in which two layers of light-blocking films are provided on both sides of the lens array according to the third embodiment.

FIG. 19 is a schematic illustration showing diffusion of ultraviolet rays by a second lens according to the third embodiment.

FIG. 20 is a schematic illustration showing a state in which two layers of light-blocking films are provided on one side of a lens array according to a fourth embodiment.

FIG. 21 is a schematic illustration showing a state in which two layers of light-blocking films are provided on both sides of a lens array according to the fourth embodiment.

### DETAILED DESCRIPTION

Embodiments of the invention provide a lens array, an image reading device having the lens array, an image forming device having the lens array, and a method for manufacturing a lens array, wherein ultraviolet curable ink which is provided between the plurality of lenses of the lens array is completely irradiated by ultraviolet light in the depth direction, to ensure complete curing of the ultraviolet curable ink forming a light blocking layer.

In general, according to one embodiment, a lens array according to one embodiment is provided with a plurality of lenses formed on a substrate and a light-blocking film formed by a plurality of layers formed between the lenses formed using an ultraviolet curable ink.

The embodiments for carrying out the disclosure will be explained below with reference to the drawings. The same components in each drawing are given the same reference numerals and will not be described repeatedly for brevity.

### First Embodiment

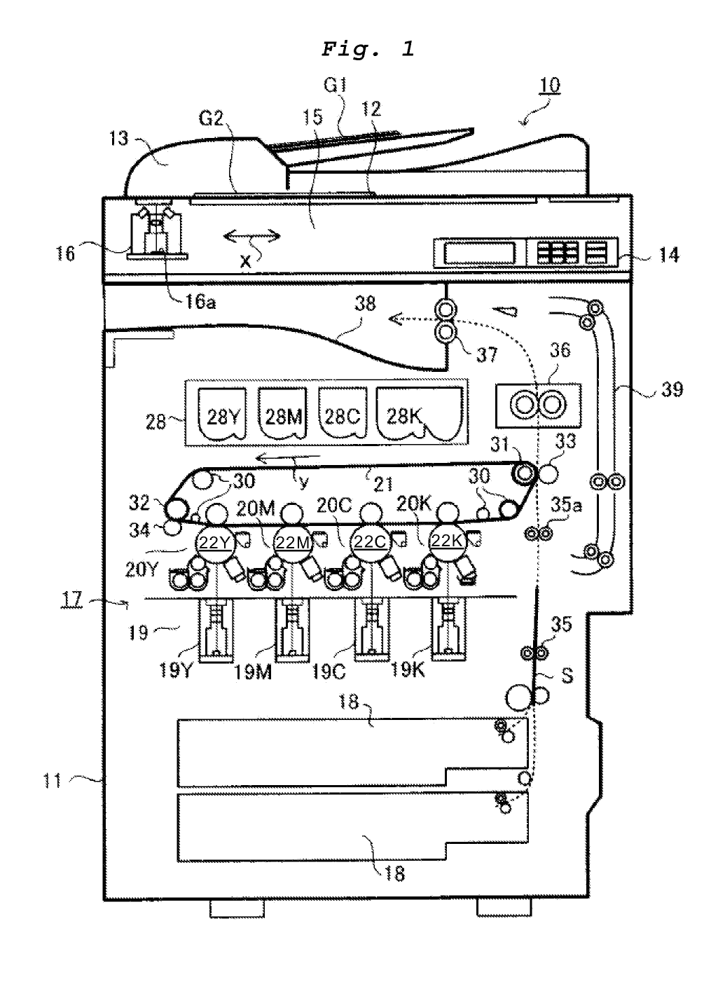

The first embodiment will be explained with reference to FIG. 1 to FIG. 12. FIG. 1 shows a color MFP (Multi-Function Peripheral) 10, which is an image forming device according to the first embodiment. A platen 12 made of a transparent glass is provided on top of a main body 11 of the MFP 10, and an automatic document feeder (ADF) 13 is provided to open and close on top of the platen 12. In addition, a control panel 14 is provided on top of the main body 11. The control panel 14 has various of keys on a touch screen and a display unit.

A scanner unit 15, which is an image reading device, is provided below the ADF 13 inside the main body 11. The scanner unit 15 reads an original document G1 sent by the ADF 13, or an original document G2 placed on top of the platen 12, and generates the image data, and is equipped with an image sensor 16a of a contact type included in an image reading unit 16. The image sensor 16a is arranged under a main scanning direction of the paper or other media being imaged therebyand extends into the plane of the drawing in FIG. 1).

In addition, the image reading unit 16 includes a light source. The light emitted from the light source irradiates the original document G2 placed on the platen, and the light reflected by the original document G2 passes through the lens array before reaching the image sensor 16a. When reading the image of the original document sent by the ADF 13, the image sensor 16a is in a fixed location as shown in FIG. 1.

A printer unit 17 is provided at a central location inside the main body 11, and a plurality of cassettes 18 for accommodating paper sheets of each type are provided at the bottom portion of the main body 11. The printer unit 17 has a photosensitive drum and a scan bed 19 including a LED, which is an exposure means, and the printer unit generates images by scanning the photosensitive drum by a light beam from the scan bed 19.

The printer unit 17 processes the image data read by the scanner unit 15, or the image data created by a PC (Personal Computer), and forms the images on a paper. The printer unit 17 is, for example, a color laser printer of a tandem system, and includes image forming units 20Y (yellow), 20M (magenta), 20C (cyan), and 20K (black) for each color. At the bottom side of an intermediate transfer belt 21, the image forming units 20Y, 20M, 20C, and 20K are arranged in parallel from the upstream side to the downstream side of the intermediate transfer belt 21. Furthermore, the scan bed 19 further has multiple scan heads 19Y (yellow), 19M (magenta), 19C (cyan), and 19K (black) that correspond to the image forming units 20Y, 20M, 20C, and 20K.

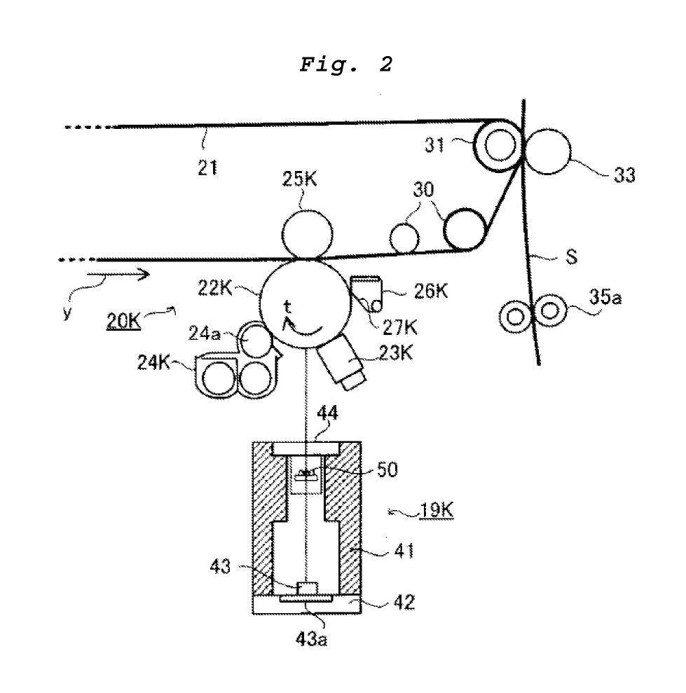

FIG. 2 shows the black (K) image forming unit 20K, among the image forming units 20Y, 20M, 20C, and 20K. Each of the image forming units 20Y, 20M, 20C, and 20K has the same configuration with the exception of color designation, so the explanation will be given below using the image forming unit 20K as representative.

The image forming unit 20K has a photosensitive drum 22K, which is an image bearing member. Arranged surrounding the photosensitive drum 22K is a cleaner 26K, or the like, equipped with a charger 23K along a rotation direction t, a developing unit 24K, a primary transfer roller 25K, and a blade 27K. The scan head 19K irradiates light to the exposure position of the photosensitive drum 22K, and forms an electrostatic latent image on the photosensitive drum 22K.

The charger 23K of the image forming unit 20K uniformly charges the surface of the photosensitive drum 22K. The developing unit 24K supplies to the photosensitive drum 22K a black toner from a developing roller 24a to which the developing bias is applied. The cleaner 26K removes the residual toner on the surface of the photosensitive drum 22k using the blade 27K.

As shown in FIG. 1, provided on top of the image forming units 20Y, 20M, 20C, and 20K are toner cartridges 28Y (yellow), 28M (magenta), 28C (cyan), and 28K (black) for supplying toner to each of the image forming units 20Y, 20M, 20C, and 20K. The toner cartridges 28Y, 28M, 28C, and 28K are toner cartridges for each color.

Referring to FIG. 1, the intermediate transfer belt 21 rotates in the direction of arrow y and extends between a drive roller 31, a driven roller 32, and a tension rollers 30. Furthermore, the intermediate transfer belt 21 is in contact so as to face photosensitive drums 22Y (yellow), 22M (magenta), 22C (cyan), and 22K (black). To the location facing the photosensitive drum 22K of the intermediate transfer belt 21, a primary transfer voltage is applied from the primary transfer roller 25K, and the toner image of the photosensitive drum 22K is primarily transferred to the intermediate transfer belt 21.

The drive roller 31 coupled to the intermediate transfer belt 21 is provided facing a secondary transfer roller 33. When a paper sheet S passes between the drive roller 31 and the secondary transfer roller 33, the secondary transfer voltage is applied to the paper sheet S from the secondary transfer roller 33, and the toner image on the intermediate transfer belt 21 is transferred to the paper sheet S. A belt cleaner 34 is provided in the vicinity of the driven roller 32 of the intermediate transfer belt 21.

As shown in FIG. 1, provided from the paper feed cassette 18 to the secondary transfer roller 33 are conveying rollers 35 and resist rollers 35a for conveying a paper sheet S taken out from the paper feed cassette 18. A fixing unit 36 is further disposed downstream of the secondary transfer roller 33. In addition, paper discharge rollers 37 are provided downstream of the fixing unit 36. The paper discharge rollers 37 discharge the paper sheet S to the paper discharge section 38.

Furthermore, a reverse conveying path 39 is provided downstream of the fixing unit 36. The reverse conveying path 39 reverses the paper sheet S, introducing it to the direction of the secondary transfer roller 33, and the path is used when performing two-sided printing.

The scan head 19K shown in FIG. 2 is facing the photosensitive drum 22K. The photosensitive drum 22k rotates at a set rotation speed and stores the charge on the surface. The light from the scan head 19K is irradiated onto the photosensitive drum 22K, exposing the photosensitive drum 22K, and forming an electrostatic latent image on the surface of the photosensitive drum 22K.

The scan head 19K has a lens array 50, and the lens array 50 is supported by a holding member 41. In addition, a support 42 is provided at the bottom portion of the holding member 41, and an LED element 43, which is the light source, is disposed on the support 42. The LED element 43 is provided at regular intervals in a straight line in the main scanning direction (into the paper). Furthermore, provided at the support 42 is a control substrate 43a containing a driver (integrated circuit—not shown) for controlling the light emission of the LED element 43.

The control substrate 43a generates the control signals of the scan head 19K based on the image data, and emits light from the LED element 43 at an amount according to the control signals. The rays emitted from the LED element 43 pass through a lens array 50 and form an image on the photosensitive drum 22K. The rays that form an image at the lens array 50 form an electrostatic latent image on the photosensitive drum 22K. The scan head 19K is equipped with a cover glass 44 at the top (light emitting side).

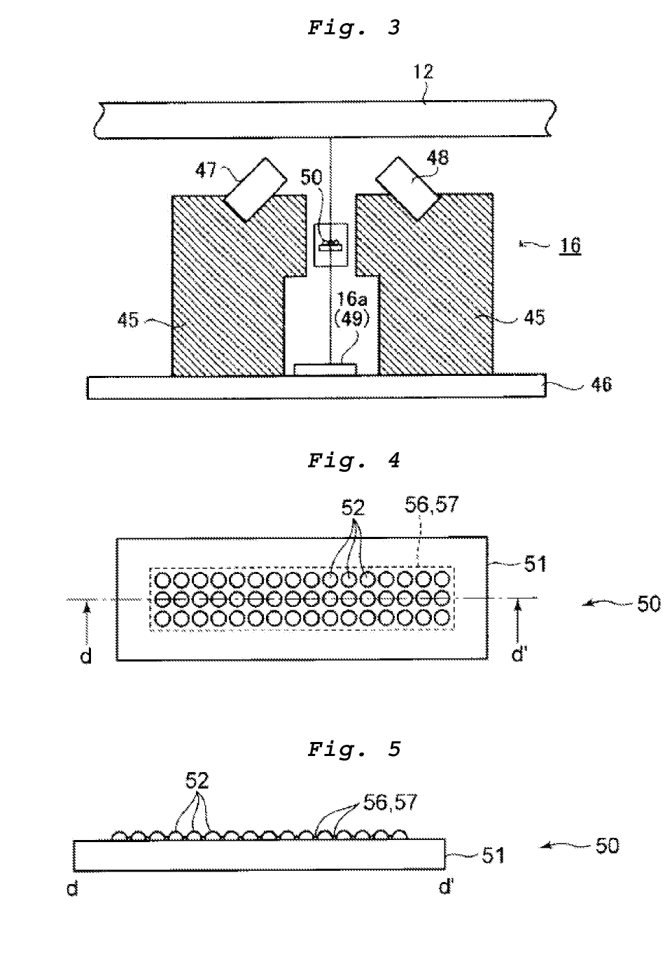

The image sensor 16a (49), shown in FIG. 3, reads the image of the original document G2 placed on the platen 12 or the image of the original document G1 fed by ADF 13 according to the operation of the control panel 14. The image sensor 16a is a one-dimensional sensor arranged in the scanning direction. Provided on the top surface of the platen 12 of a chassis 45, which is provided on top of the substrate 46, are two LED line lighting systems 47 and 48 so as to extend in the scanning direction (into the paper). The light source for irradiating the original document is not limited to the LED. Fluorescent tubes, xenon tubes, cold-cathode tubes, organic ELs, or the like, may also be used.

The lens array 50 is supported between the LED line lighting systems 47 and 48 on top of the chassis 45, and the image sensor 49, including a CCD or a CMOS, is installed in the substrate 46 at the bottom of the chassis 45. The LED line lighting systems 47 and 48 illuminate an image reading position of the original document on top of the platen 12 and the light reflected at the image reading position is incident on the lens array 50. The lens array 50 functions as an erecting magnifying lens. The light that is incident on the lens array 50 is emitted from the light-emitting surface of the lens array 50 and forms an image on the sensor 49. The imaged light is converted into an electrical signal by the sensor 49, and is transferred to a memory unit (not shown in the drawing) of the substrate 46.

Although the multi-function peripheral (MFP) has been explained as an example of an image forming device in this embodiment, the image forming device is not limited to an MFP. The image forming device may also be, for example, a stand-alone printer or a stand-alone scanner.

Next, the lens array 50 will be explained. As shown in FIG. 4 to FIG. 6, the lens array 50 is equipped with a plurality of lenses 52 formed on or in, for example, a transparent substrate 51. The lens array 50 is equipped with a first light-blocking film 56 in a black color having a thickness of 12 μm formed between each lens 52, and a second light-blocking film 57 in a black color having a thickness of 12 μm laminated on the first light-blocking film 56. The first light-blocking film 56 and the second light-blocking film 57 are formed, for example, using an ultraviolet curable ink having the same characteristics. The lens 52 and the substrate 51 of the lens array are, for example, formed by a molding process.

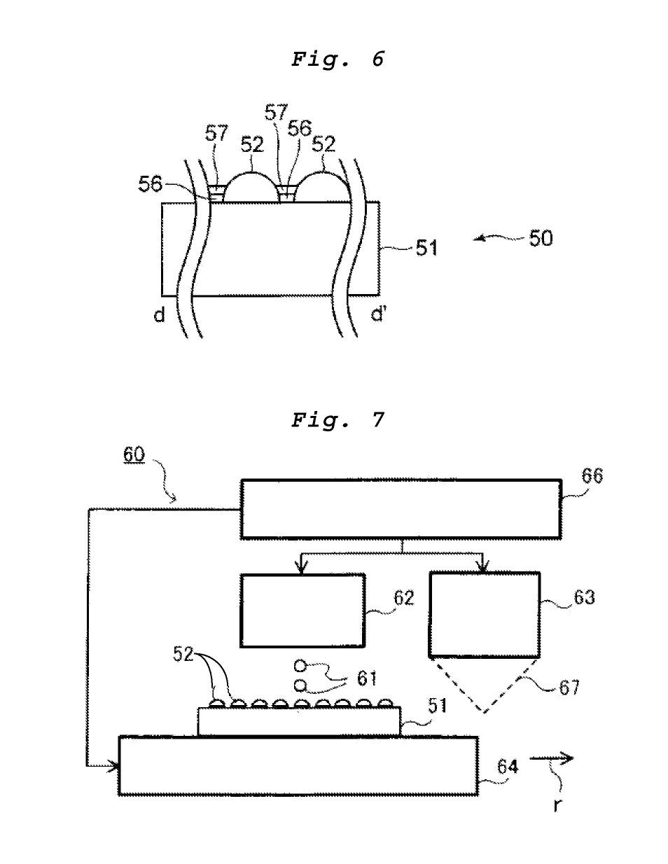

The first light-blocking film 56 and the second light-blocking film 57 are formed using a light-blocking film forming device 60 shown in FIG. 7. The light-blocking film forming device 60 cures, using an ultraviolet light 67, an ultraviolet curable ink 61 discharged by an ink-jet method, and first, forms the first light-blocking film 56. The light-blocking film forming device 60 repeats the same formation step as the formation step of the first light-blocking film 56, and forms the second light-blocking film 57 by overlapping the second light-blocking film 57 on the first light-blocking film 56. The light-blocking film forming device 60 is equipped with an inkjet printing unit 62, an ultraviolet irradiation device 63, a conveyor bed 64, and a control unit 66.

The conveyor bed 64, which secures and supports the substrate 51 provided with a plurality of lenses 52 extending upwards therefrom moves in the direction of arrow r. The conveyor bed 64 transfers the substrate 51 to a position adjacent to the inkjet printing unit 62 and then to a position adjacent to and underlying the ultraviolet irradiation device 63. The inkjet printing unit 62 discharges the ultraviolet curable ink 61 between each lens 52 from above the substrate 51. The ultraviolet irradiation device 63 irradiates the ultraviolet light 67 on the ultraviolet curable ink 61 discharged onto the substrate 51, from above the substrate 51.

The control unit 66 controls the inkjet printing unit 62, the ultraviolet irradiation device 63, and the conveyor bed 64. The control unit 66 controls, for example, the conveying speed, or the conveying timing of the conveyor bed 64. The control unit 66 controls the amount of ink discharged by the inkjet printing unit 62. Control of the amount of ink discharged is, for example, controlled by adjusting the voltage for discharging the ink, or controlled by adjusting the number of droplets in a multi-drop process. The control unit 66 controls the wavelength of the ultraviolet light of, for example, the ultraviolet irradiation device 63.

In the light-blocking film forming device 60, the supply of the ultraviolet curable ink 61 may be carried out by coating using an ink coating device, instead of an inkjet method. Or, in order to form the light-blocking films 56 and 57, instead of moving the conveyor bed 64, the conveyor bed 64 may be secured, and the inkjet printing unit 62 and the ultraviolet irradiation device 63 may be moved relative to the stationary conveyor bed 64.

The ultraviolet curable ink will be explained and examples of materials of the ultraviolet curable ink will be provided.

### (Light-Blocking Material)

Optical light-blocking properties and reflection characteristics are considered in the light-blocking material for forming the light-blocking film between a plurality of lenses. Next, flight performance, dispersion stability, etc. are considered for the inkjet ultraviolet curable ink. A light-absorbing pigment can be exemplified as such material. For example, carbon-based pigments, such as carbon black, refined carbon, carbon nanotubes, etc.; metal oxide pigments, such as iron black, zinc oxide, titanium oxide, chromium oxide, iron oxide, etc.; sulfide pigments, such as zinc sulfide, etc.; phthalocyanine pigments; pigments including metal sulfates, carbonates, silicates, and phosphates; pigments including metal powder such as aluminum powder, bronze powder, and zinc powder, can be used.

### (Reactive Material)

The material that becomes the backbone of the light-blocking film is a light curable material, and it includes a reactive material by the polymerization of the oligomer, the reactive monomer having a polymerizable functional group; and a photoinitiator for initiating the polymerization thereof. A wide variety of reactive materials have been used in various applications, and it can be broadly divided into a radical type and a cationic type.

Acrylic monomers and oligomers having an acryloyl functional group are typical in the radical type; polymerization is promoted from the radical generated from the photoinitiator irradiated by the light. Coating, ink, optical material, resist, and so on can also be used. However, there are also disadvantages, such as generation of oxygen inhibition in polymerization and relatively significant contraction in volume after curing. For applications, it is necessary to have the disadvantages under control.

Exemplified as the cationic type are a cyclic ether compound represented by an epoxy or oxetane compound, a vinyl ether compound having a vinyl ether group, or the like, and exemplified as the photoinitiator is the one that carries out polymerization using proton generation by light irradiation. Of these, the cyclic ether compound can be exemplified as the feature due to minimal volume shrinkage after curing, accompanied by excellent adhesion to the substrate. In addition, polymerization can be carried out without generating oxygen inhibition, and it has excellent performance in forming a thin film, so these points are different from those in the radical type.

As the light-blocking film of the lens array, taking into consideration the characteristic mentioned above, the materials that have compatibility with the ink characteristics as the inkjet ultraviolet curable ink can be appropriately selected and used. As long as the ink material of this embodiment satisfies the requirements of its compatibility with performances such as light blocking properties as a light-blocking film, reflection characteristics, film curing strength, ultraviolet curing conditions, or the like; physical properties such as viscosity, surface tension, etc. as the characteristic of inkjet ultraviolet curable ink; dispersion stability of the light-blocking material; and the head member, it is not particularly limited. Concrete examples will be described below.

Exemplified as the material of a radical type are oligomers represented by the following, depending on the number having acryloyl groups in the molecule, monomers such as monofunctional acrylate, bifunctional acrylate, tri- or higher polyfunctional acrylate, etc.; and polyester acrylate, urethane acrylate, epoxy acrylate, etc. Of those, the monofunctional monomer is often used as a reactive diluent, and as the inkjet ink, it plays an important role as the material for adjusting viscosity.

As a concrete example, the following can be exemplified: acrylic acid adduct of isobornyl acrylate, acryloyl morpholine, dicyclopentadienyl acrylate, phenyl glycidyl ether; 2-hydroxy ethyl acrylate, 2-hydroxy propyl acrylate, 2-hydroxy butyl acrylate, 2-hydroxy hexyl acrylate, ethyl carbitol acrylate, tetrahydrofurfuryl acrylate, 2-acryloyloxyethyl phthalate, benzyl acrylate, etc.; methacrylic acrylate such as 2-hydroxyhexyl methacrylate, acryl methacrylate, benzyl methacrylate, cyclohexyl methacrylate, etc.

Exemplified as the bifunctional acrylate are neopentyl glycol diacrylate, nonanediol diacrylate, tripropylene glycol diacrylate, tricyclodecane dimethanol diacrylate, EO adduct acrylate of bisphenol A, etc., and exemplified as the polyfunctional acrylate are triacrylates, such as trimethylolpropane triacrylate, pentaerythritoltriacrylate, dipentaerythritol pentaacrylate, isocyanuric acid EO adduct, etc. Other than those of acrylate-base, N-vinylpyrrolidone, N-vinyl caprolactam, etc. are also useful as diluents.

An epoxy compound, an oxetane compound, a vinyl ether compound, etc. can be exemplified as the material of a cationic type.

The following compounds can be exemplified as the epoxy compound: a compound having a hydrocarbon group that has a divalent aliphatic skeleton or an alicyclic skeleton, or a compound having an epoxy group or an alicyclic epoxy group to one of or both divalent groups partially having an aliphatic skeleton or an alicyclic skeleton. For example, it is possible to employ alicyclic epoxy such as Celloxide 2021, Celloxide 2021A, Celloxide 2021P, Celloxide 2081, Celloxide 2000, and Celloxide 3000 manufactured by Daicel Chemical Industries, Ltd.; Cyclomer A200, Cyclomer M100, which are (meth)acrylate compounds having an epoxy group; methacrylate having a glycidyl methyl group such as MGMA; glycidol, which is a low molecular epoxy compound; β-methyl epichlorohydrin; α-pinene oxide, α-olefin monoepoxide having 12 to 14 carbon atoms; α-olefin monoepoxide having 16 to 18 carbon atoms; epoxidized soy bean oil such as Daimac S-300K; epoxidized linseed oil such as Daimac L-500; and polyfunctional epoxy compounds such as Epolead GT301 and Epolead GT401.

Moreover, it is also possible to use alicyclic epoxy, such as Cylacure, product of Dow Chemical Co., Ltd, U.S.; low molecular weight phenol compounds that are hydrogenated and aliphatized with terminal hydroxyl group thereof being substituted by a group having epoxy; glycidyl ether compounds such as polyhydric aliphatic alcohols/alicyclic alcohols such as ethylene glycol and glycerol, neopentyl alcohol and hexanediol, trimethylolpropane; and glycidyl esters of hexahydrophthalic acid or hydrogenated aromatic polyhydric carboxylic acid.

Exemplified as the oxetane compounds are, for example, compounds in which more than one oxetane-containing groups are introduced to alicyclic such as (di[1-ethyl(3-oxetanol)]methyl ether, 3-ethyl-3-(2-ethylhexyloxy methyl) oxetane, [(1-ethyl-3-oxyetanol)methoxy]cyclohexane, bis[(1-ethyl-3-oxetanol)methoxy]cyclohexane, bis[(1-ethyl-3-oxetanol)methoxy]norbonane; ether compounds in which oxetane-containing alcohols such as 3-ethyl-3-hydroxymethyl oxetane is dehydrated and condensed to aliphatic polyhydric alcohols such as ethylene glycol, propylene glycol, neopentyl alcohols or the like. In addition, exemplified as the oxetane compounds that contain aromatic skeletons are, for example, 1,4-bis((1-ethyl-3 oxetanil)methoxy)benzene, 1,3-bis((1-ethyl-3 oxetanil)methoxy)benzene, 4,4′-bis((3-ethyl-3 oxetanil)methoxy)biphenyl, phenol novolac oxetane, or the like.

Exemplified as the vinyl ether compounds are 2-ethylhexylvinyl ether, buntan diol divinyl ether, cyclohexanedimethanol divinyl ether, cyclohexanedimethanol monovinyl ether, dithylene glycol monovinyl ether, dithylene glycol divinyl ether, hexanediol divinyl ether, triethylene glycol divinyl ether, 4-hydroxybutyl vinyl ether, or the like. When a decrease in viscosity and an improvement in the degree of hardness in terms of curing are required, in addition to the improvement in the curing rate, it is preferred to blend alone, or in combination, the vinyl ether compounds expressed by the following formula (1) in a liquid ink.

Because of the noticeable inhibition of polymerization by pigment in the vinyl ether compound bonded with a methylene group such as aliphatic glycol derivatives and cyclohexanedimethanol, it has been difficult to use it as ink to date. However, as shown in the following formula (1), the compound in which a vinyl ether group directly having an alicyclic skeleton, a terpenoid skeleton, or an aromatic skeleton has excellent curing performances even when it has a pigment. The blending amount of these compounds is preferred to be the ratio of equal to, or less than, 50 parts by weight with respect to the entire liquid ink in order to maintain its thermoplasticity; however, when it is desired to further have a higher solvent resistance and a degree of hardness even when the thermoplasticity is lost, it may further be increased to the total amount of solvent to be cured by acid.

R13-R14-(R13)ₚ Formula (1)

In the formula (1) above, for R13, at least one represents a vinyl ether group, and it represents a substituent selected from a vinyl ether group and a hydroxyl group. R14 is a (p+1) valent group selected from an alicyclic skeleton, or a skeleton having an aromatic ring, and p represents a positive integer including 0. However, when R14 is a cyclohexane ring skeleton and p is 0, at least one carbon on the ring has a ketone structure. Exemplified as the organic group R14 of (p+1) valent are, for example, (p+1) valent groups containing a benzene ring, a naphthalene ring, a biphenyl ring; and (p+1) valent groups to be derived from a cycloalkane skeleton, a norbornane skeleton, a adamantane skeleton, a tricyclodecane skeleton, a tetracyclododecane skeleton, a terpenoid skeleton, and a cholesterol skeleton.

To be precise, it is also possible to use a compound in which the hydrogen atom of the hydroxyl group in phenol derivatives, as well as cycloaliphatic polyol, such as cyclohexane (poly)ol, norbornane (poly)ol, tricyclodecane (poly)ol, adamantane (poly)ol, benzene (poly)ol, naphthalene (poly)ol, anthracene (poly)ol, biphenyl (poly)ol, or the like has been replaced by a vinyl group. In addition, exemplified is also a compound in which the hydrogen atom of the hydroxyl group in the polyphenol compound such as polyvinyl phenol, phenol novolac, etc. has been replaced with a vinyl group. The compounds mentioned above are desirable because the volatility will be reduced even when a portion of the hydroxyl group remains, and even when a portion of the methylene atoms of an alicyclic skeleton has been replaced with a ketone group. In particular, since the cyclohexyl monovinyl ether compound is highly volatile, it is preferred to oxidize the cyclohexane ring to at least a cyclohexanone ring when using the cyclohexyl monovinyl ether compound.

Next, a radical type and a cationic type will be separated as an example of the photoinitiator, and those used in general will be enumerated.

For radical type, there are benzoin ethers, acetophenones, phosphine oxides; for example, a cleavage type such as 1-hydroxycyclohexylphenylketone, diethoxyacetophenone, 2-hydroxy-2-methyl-1-phenylpropane-1-on, 2-benzyl-2-dimethylamimo-1-(4-morpholinophenyl)-butanone-1, or the like; a hydrogen abstraction type such as benzophenone, 2,4-diethyl thioxanthone, isopropyl thioxanthone, or the like.

It is possible to use the following as the cationic type: onium salts, diazonium salts, quinone diazide compounds, organic halide, aromatic sulfonate compounds, bisulphone compounds, sulfonyl compounds, sulfonate compounds, sulfonium compounds, sulfamide compounds, iodonium compounds, sulfonyl diazomethane compound, and mixtures thereof.

More specifically, exemplified are triphenyl sulfonium triflate, diphenyl iodonium triflate, 2,3,4,4-tetrahydroxy benzophenone-4-naphthoquinone diazide sulfonate, 4-N-phenyl-amino-2-methoxyphenyl diazonium sulfate, 4-N-phenylamino-2-methoxyphenyl diazonium-p-ethyl phenyl sulfate, 4-N-phenylamino-2-methoxyphenyl diazonium 2-naphthylsulphate, 4-N-phenylamino-2-methoxyphenyl diazonium phenyl-sulfate, 2,5-diethoxy-4-N-4′-methoxyphenyl carbonyl phenyl diazonium-3-carboxy-4-hydroxyphenyl sulfate, 2-methoxy-4-N-phenyl phenyl diazonium-3-carboxy-4-hydroxyphenyl sulfate, diphenyl sulfonyl methane, diphenyl sulfonyl diazomethane, diphenyl sulfone, α-methyl benzoin tosylate, pyrogallol trimesylate, and benzoin tosylate, or the like.

The ultraviolet curable ink 61 is prepared by: carrying out a step of dispersing a (light-blocking material) into (the reactive monomer) using these materials; a step of adding to the obtained dispersion liquid an appropriate monomer, oligomer and a photoinitiator, as well as a polymerization inhibitor, if necessary; followed by mixing and stirring it; and finally a step of purification such as filtration or centrifugation for removing coarse particles and unwanted solids.

In the polymerization inhibitor, there are the one in the case of a cationic type, and the one in the case of a radical type. In the case of a cationic type, exemplified are n-hexylamine, dodecylamine, aniline, dimethylaniline, diphenylamine, triphenylamine, diazabicyclooctane, diazabicycloundecane, 3-phenyl-pyridine, 4-phenyl pyridine, lutidine, 2,6-di-t-butyl pyridine, or the like. In the case of a radical type, exemplified are DPPH (1,1-diphenyl-2-picrylhydrazyl), TEMPO (2,2,6,6-tetramethylpiperydinyl-1-oxyl), p-benzoquinone, chloranil, nitrobenzene, hydroquinone (HQ), methyl hydroquinone (MEHQ), t-butyl catechol, dimethylaniline, or the like.

As for the physical properties of the ultraviolet curable ink 61, as long as the average particle diameter of the light-blocking material is less than 300 nm, there will be no effect to the flight performance by the inkjet printing unit 62. In addition, the viscosity value of the ultraviolet curable ink 61 may be provided in the range of 5-30 mPa·s at 25° C., and the surface tension values to the range of 22-40 mN/m. The viscosity value and the surface tension value of the ultraviolet curable ink 61 can be set by the combination of the monomer, the oligomer, or the surfactant.

In order for the ink to flow easily to the narrow regions between the plurality of lenses 52, a contact angle between the substrate 51 and the ultraviolet curable ink 61 is less than 20 degrees at 25° C.

The light-blocking film of the lens array generally can block stray lightswitch would otherwise pass through the substrate 51 between the plurality of lenses and thereby affect image quality. The greater the light blocking capability, the more useful it is in the characteristic of the lens array. The light blocking property of the light-blocking film can be obtained by measuring the optical density (transmission density). The measurement of the optical density can be performed using, for example, a 361T densitometer manufactured by X-rite. The light-blocking film can block the transmitted light as long as its optical density is greater than 6. (The optical density is the logarithm that uses the opacity of 10 as the base, so the larger the amount of dimming light, the larger its value will be. When the optical density is 6, the light transmittance will be 1/1 million %.

FIG. 8 shows the relationship between the thickness of the light-blocking (shielding) film and the optical density, as the blocking characteristics when carbon black is used as the light-blocking material. The evaluation of the light-blocking properties is performed for the ultraviolet curable ink having 3.5 wt % in carbon black content and the ultraviolet curable ink having 7.5 wt % in carbon black content. Curing of the ultraviolet curable ink is performed using ultraviolet rays having 2000 mW/cm² in irradiance, 400 mJ/cm² density, and 365 nm in wavelength.

From FIG. 8, the ultraviolet curable ink having 3.5 wt % of the light blocking material can obtain sufficient light blocking properties with the film thickness of greater than about 24 μm. It can be confirmed that the ultraviolet curable ink having 7.5 wt % of the light blocking material can obtain sufficient light blocking properties with a film thickness of greater than about 12 μm. As a result, it can be confirmed that preparing a thick light-blocking film formed by the ultraviolet curable ink, or elevating the weight ratio of the light blocking material in the ultraviolet curable ink can achieve sufficient light blocking properties as the light-blocking film for the lens array 50.

In the first embodiment, the content of carbon black in the ultraviolet curable ink 61 used in the first light-blocking film 56 and the second light-blocking film 57 is set to, for example, 3.5 wt %. The first light-blocking film 56 and the second light-blocking film 57 are formed so that each has a thickness of 12 μm, and the total of film thickness of the first light-blocking film 56 and the second light-blocking film 57 on top of the lens array 50 is 24 μm. The ultraviolet rays from the ultraviolet irradiation device 63 has, for example, 2000 mW/cm² in irradiance, 400 mJ/cm² density, and 365 nm in wavelength.

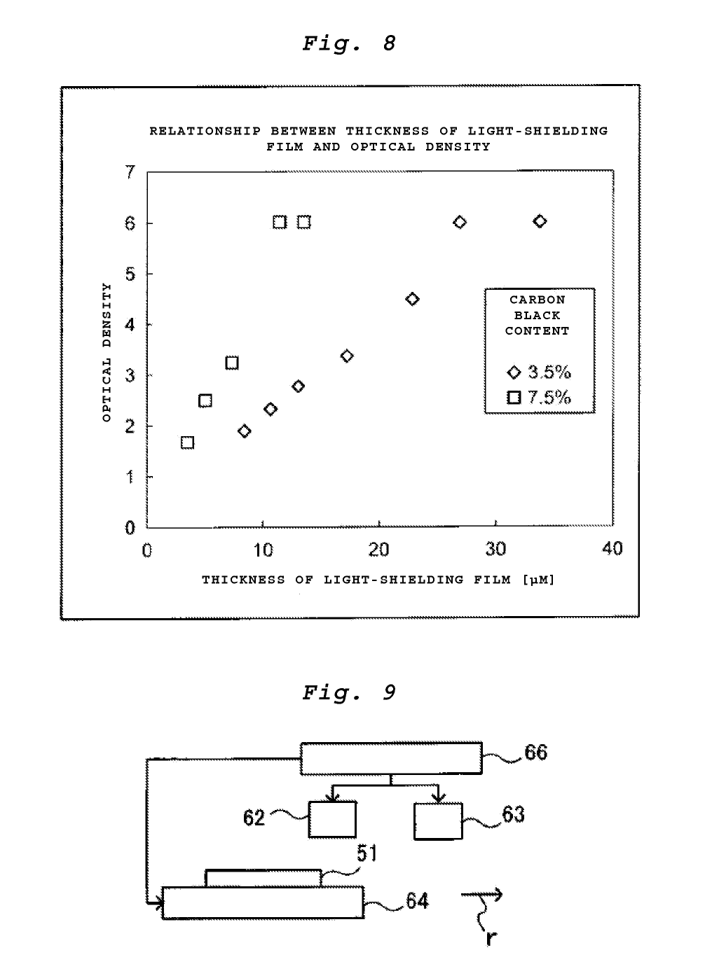

The manufacturing method for forming the first light-blocking film 56 and the second light-blocking film 57 between the plurality of lenses 52 will be explained with reference to FIG. 9 to FIG. 12. In order to form the first light-blocking film 56, as shown in FIG. 9, the substrate 51 is fixed to the conveyor bed 64, and the conveyor bed 64 is moved in the direction of the arrow r. When the substrate 51 arrives at the inkjet printing unit 62, the inkjet printing unit 62 discharges the ultraviolet curable ink 61 between the plurality of lenses 52 of the substrate 51 from above the substrate 51 as the substrate 51 moves in the direction of the arrow r, as shown in FIG. 10. The discharge amount of the ultraviolet curable ink 61 by the inkjet printing unit 62 is set to an amount in which the film thickness of the first light-blocking film 56 becomes at least 12 μm, after curing.

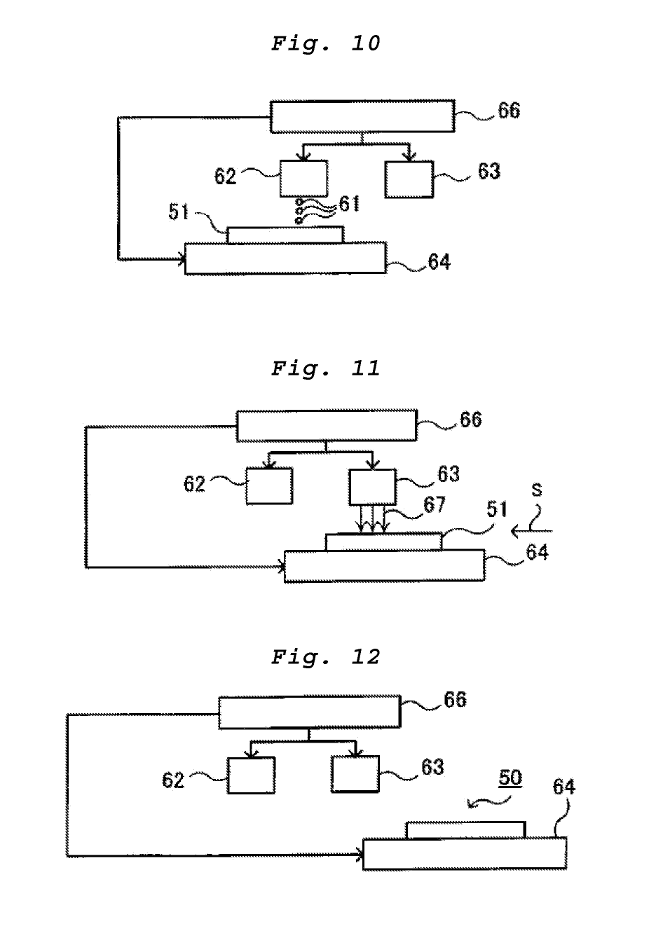

Following the movement of the conveyor bed 64, when the substrate 51 arrives at the ultraviolet irradiation device 63, as shown in FIG. 11, the ultraviolet irradiation device 63 irradiates the ultraviolet light 67 on the ultraviolet curable ink 61 from above the substrate, and cures the ultraviolet curable ink 61. The time period for irradiation of the ultraviolet curable ink 61 is set to be, for example, longer than 2 seconds. And, the conveyor bed 64 transports the substrate 51 to which the ultraviolet curable ink 61 has been supplied to the position of the ultraviolet irradiation device 63 in the state of being held horizontally. The ultraviolet curable ink 61 supplied to the substrate 51 naturally spreads between the plurality of lenses 52 on the surface of the substrate to form a relatively uniform thickness ink layer before the ultraviolet light 67 is irradiated thereon.

The discharge amount of the ultraviolet curable ink 61 by the inkjet printing unit 62 is adjusted so that the film thickness of the first light-blocking film 56 becomes 12 μm where ink having 3.5% carbon black content is employed. Thus even when the ultraviolet light 67 from the ultraviolet irradiation device 63 has been somewhat blocked by the ultraviolet curable ink 61 itself, it can sufficiently reach the full thickness of the ink layer on the substrate 51 and thereby cure the entire thickness of the ultraviolet curable ink 61. When the substrate 51 passes through the ultraviolet irradiation device 63, the ultraviolet curable ink 61 on the substrate 51 is sufficiently cured, and the first light-blocking film 56 having a uniform film thickness of 12 μm among the plurality of lenses 52 is obtained.

After forming the first light-blocking film 56, the conveyor bed 64 is moved in the direction of the arrows (shown in FIG. 11), and the substrate 51 is returned to the position as shown in FIG. 9. The light-blocking film forming device 60 repeats the same step as the formation step of the first light-blocking film 56 to the substrate 51, and deposits the second light-blocking film 57 having a uniform film thickness of 12 μm on top of the first light-blocking film 56. The light-blocking film forming device 60 irradiates the ultraviolet light 67 by the ultraviolet irradiation device 63 after supplying the ultraviolet curable ink 61 among the plurality of lenses 52 of the substrate 51 from the first light-blocking film 56 by the inkjet printing unit 62, by the movement of the conveyor bed 64 in the direction of the arrow r.

The amount of the ultraviolet curable ink 61 supplied to the top of the first light-blocking film 56 from the inkjet printing unit 62 has been adjusted to an amount so that the film thickness of the second light-blocking film 57 becomes 12 μm where ink having 3.5% carbon black content is used. Due to the set thickness, the ultraviolet light 67 from the ultraviolet irradiation device 63 sufficiently reaches the surface of the first light-blocking film 56, i.e., reaches the entire volume of the second light blocking film 57, even when it has been somewhat blocked by the partially cured ultraviolet curable ink 61 in the second light blocking layer 57. When the substrate 51 passes through the ultraviolet irradiation device 63, the ultraviolet curable ink 61 on the substrate 51 is sufficiently cured in the thickness dimension, and the second light-blocking film 57 having a uniform film thickness of 12 μm is laminated on the first light-blocking film 56.

The manufacture of the lens array 50 onto which the first light-blocking film 56 and the second light-blocking film 57 have been laminated among the plurality of lenses 52 on top of the substrate 51, that passes through the ultraviolet irradiation device 63, has been completed (FIG. 12). The lens array 50 having the light-blocking films is provided with superior light blocking property at a film thickness of 24 μm in total for both the first light-blocking film 56 and the second light-blocking film 57, enabling the lens array 50 to adequately block stray light. After evaluating the performance of the first light-blocking film 56 and the second light-blocking film 57 formed on the lens array 50 with pencil hardness (2B), it is revealed that the first light-blocking film 56 and the second light-blocking film 57 have sufficient hardness with no scratching, indicating full curing of the film layers 56 and 57.

In contrast to this, a first conventional comparative example is described. Using an ultraviolet curable ink having a content of carbon black of 3.5 wt %, when the ink is discharged to the substrate 51 in an amount to provide a film thickness after curing of 24 μm, the light-blocking film of the first comparative example had scratches caused by the pencil (2B), causing it to peel off, so that a sufficient degree of hardness could not be achieved. As a second comparative example, using the ultraviolet curable ink having a content of carbon black of 7.5 wt %, when the ink is discharged to the substrate 51 in an amount to provide a film thickness after curing of 12 μm, the light-blocking film of the second comparative example had scratches by the pencil (2B), causing it to peel off, so that a sufficient degree of hardness could not be achieved.

Although the reactive material used for the ultraviolet curable ink 61 is not limited, using acrylic material as the reactive material inhibits the polymerization reaction due to oxygen in the air, making the surface of the ultraviolet curable ink hard to cure. When the surface of the ultraviolet curable ink 61 does not harden due to oxygen inhibition, it is also possible to provide a step of cleaning the lens array 50 after irradiation of the ultraviolet light 67 in order to remove the uncured ultraviolet curable ink 61. The step of cleaning the uncured ultraviolet curable ink 61 is optional; for example, it may be a step of immersion in an alcohol-based solvent, or a step of ultrasonic cleaning in an organic solvent.

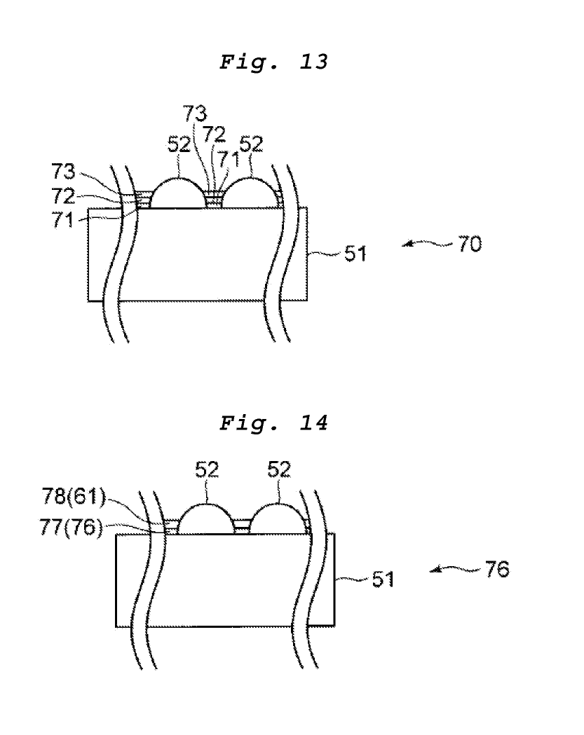

And the number of layers of light-blocking films laminated among the plurality of lenses 52 is not limited. As an alternative example, as shown in FIG. 13, for example, the light-blocking films may also be formed into three layers. Provided among the plurality of lenses 52 of a lens array 70 in FIG. 13 are a first light-blocking film 71 in black color with a thickness of 8 μm, a second light-blocking film 72 in black color with a thickness of 8 μm laminated on top of the first light-blocking film 71, and a third light-blocking film 73 in black color with a thickness of 8 μm laminated on top of the second light-blocking film 72. The first light-blocking film 71 to the third light-blocking film 73 are formed using the ultraviolet curable ink 61 having the same characteristics.

The light-blocking film forming device 60 irradiates an ultraviolet light 67 to the ultraviolet curable ink 61 discharged from the inkjet printing unit 62, (described in FIGS. 9-11) and forms the first light-blocking film 71 having a film thickness of 8 μm among the plurality of lenses 52. The light-blocking film forming device 60 repeats the same formation step as that for the first light-blocking film 71, and sequentially layers the second light-blocking film 72 and the third light-blocking film 73 on top of the first light-blocking film 71. For the first light-blocking film 71 to the third light-blocking film 73, the ultraviolet curable ink 61 is sufficiently irradiated by the ultraviolet light 67 in each formation step to ensure curing of each layer. The lens array 70 having the light-blocking films with superior light blocking properties and at a film thickness of 24 μm in total for both the first light-blocking film 71 to the third light-blocking film 73, and sufficiently blocks stray light.

When laminating a light-blocking film among the plurality of lenses 52, instead of repeating the formation step of the light-blocking film using a pair of the inkjet printing unit 62 of the light-blocking film forming device 60 and the ultraviolet irradiation device 63, a plurality of light-blocking films may also be sequentially laminated by using a light-blocking film forming device equipped with a plurality of inkjet printing units and the ultraviolet irradiation devices for forming each light-blocking film.

The layer thickness of the light-blocking film laminated among the plurality of lenses 52 is optional for each film. For example, the thickness of the first layer of two layers may be formed thicker than the thickness of the second layer on the surface side. When the thickness of the first layer at the lower side is made thicker, the ultraviolet light may be irradiated from the lower side through a transparent conveyor bed, and the ultraviolet light can be irradiated on both sides of the ultraviolet curable ink, which cures the ultraviolet curable ink reliably.

The light blocking properties of each light-blocking film laminated among the plurality of lenses 52 is not limited. As in the another alternative example as shown in FIG. 14, each light-blocking film can also be formed by using the ultraviolet curable ink 61 having a 3.5 wt % carbon black content and an ultraviolet curable ink 76 having a 7.5 wt % carbon black content. For example, among the plurality of lenses 52 of a lens array 76 of FIG. 14, a second light-blocking film 78 having a thickness of 12 μm using the ultraviolet curable ink 61 having 3.5 wt % carbon black content is laminated on top of a first light-blocking film 77 having a thickness of 7 μm using the ultraviolet curable ink 76 having 7.5 wt % carbon black content. The total of the film thickness of the first light-blocking film 77 and the second light-blocking film 78 is 19 μm in this alternative example. The ultraviolet light passes through the second light-blocking film 78 (due to the lower carbon black content) and sufficiently cures both of the first light-blocking film 77 and the second light-blocking film 78.

In order to form the first light-blocking film 77, the light-blocking film forming device 60 (described in FIGS. 9-11) irradiates the ultraviolet light 67 on the ultraviolet curable ink 76 after discharging the ultraviolet curable ink 76 having 7.5 wt % carbon black content to the substrate 51 by the inkjet printing unit 62 to form the first light-blocking film 77 having a 7 μm film thickness among the plurality of lenses 52. In order to form the second light-blocking film 78, the light-blocking film forming device 60 irradiates the ultraviolet light 67 on the ultraviolet curable ink 61 after discharging the ultraviolet curable ink 61 having 3.5 wt % carbon black content to the first light-blocking film 77 by the inkjet printing unit 62 to form the second light-blocking film 78 having a 12 μm film thickness on top of the first light-blocking film 77.

The first light-blocking film 77 and the second light-blocking film 78 are cured in a reliable manner by sufficiently irradiating the ultraviolet light 67 on the ultraviolet curable ink 76 and the ultraviolet curable ink 61 in each formation step. In the lens array 76, using the ultraviolet curable ink 76 having 7.5 wt % carbon black content, a light-blocking film of an upper layer may be laminated after forming a light-blocking film of a lower layer using the ultraviolet curable ink 61 having 3.5 wt % carbon black content. As in the other alternative example, when forming onto the lower layer the first light-blocking film 77 that has a large amount of carbon black content, the ultraviolet light can be irradiated on both surfaces of the ultraviolet curable ink 76 by, for example, making the conveyor bed transparent. Thus, the ultraviolet curable ink can be cured in a more reliable manner by irradiating the ultraviolet light from the conveyor bed in addition to the ultraviolet light from above.

The light blocking material that constitutes the ultraviolet curable ink is not limited to carbon black; each type of the light blocking material listed above can also be used. When using a pigment as the light blocking material, several types of pigments may be mixed. In such cases, changing the mixing ratio can change the light blocking performance of the light-blocking film formed by the ultraviolet curable ink.

According to the first embodiment, among the plurality of lenses 52, the second light-blocking film 57 is formed on top of the first light-blocking film 56. In order to make the film thickness of the light-blocking film formed at the first formation step thinner, the first light-blocking film 56 and the second light-blocking film 57 are formed separately from each other. So at each formation step, the ultraviolet light 67 sufficiently irradiates the ultraviolet curable ink 61 to ensure curing of the ultraviolet curable ink 61. The lens array 50 is equipped with light-blocking films with a film thickness of 24 μm in total for both the first light-blocking film 56 having 12 μm in film thickness and the second light-blocking film 57 having 12 μm in film thickness. This enables superior light blocking properties, enabling the lens array 50 to reliably block stray light, and provides a lens of good quality.

### Second Embodiment

Next, a second embodiment will be explained. A lens array according to the second embodiment includes light-blocking films having a plurality of layers on both major sides of the lens array. The plurality of layers are disposed between a plurality of lenses on both major sides of the substrate. In this second embodiment, the same components that are described in the first embodiment will be given the same reference numerals and detailed explanations of the components will be omitted for brevity.

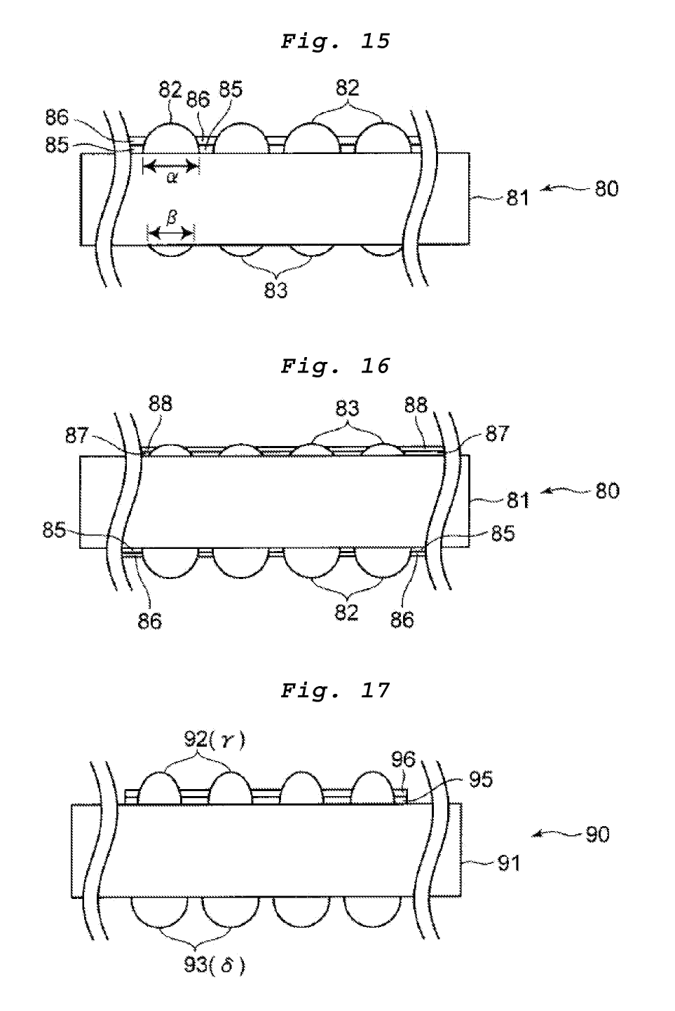

A lens array 80 according to the second embodiment as shown in FIG. 15 and FIG. 16 is provided with a plurality of first lenses 82 having base dimension α at each of the two surfaces of a transparent substrate 81, and a plurality of second lenses 83 having an base dimension β. The base dimension α of the first lenses 82 is wider than the opening width β of the second lenses 83. Layered in between the plurality of the first lenses 82 of the lens array 80 are a first light-blocking film 85 and a second light-blocking film 86, each having a 12 μm thickness. The total of the film thickness of the first light-blocking film 85 and the second light-blocking film 86 is 24 μm. Laminated in between the plurality of the second lenses 83 of the lens array 80 are a third light-blocking film 87 and a fourth light-blocking film 88, each having a 12 μm thickness. The total of the film thickness of the third light-blocking film 87 and the fourth light-blocking film 88 is 24 μm. The first to the fourth light-blocking films 85-88 are formed using the ultraviolet curable ink 61 having the same characteristics, the ink of which has 3.5 wt % carbon black content.

In the lens array 80, the first light-blocking film 85 at the first lenses 82 side having the wider base dimension α and the second light-blocking film 86 are formed first. The light-blocking film forming device 60 (FIG. 10) forms the first light-blocking film 85 by discharging the ultraviolet curable ink 61 in an amount so that the film thickness of the first light-blocking film 85, after curing, becomes 12 μm between the plurality of the first lenses 82. The first light-blocking film 85 is then cured by exposing the ultraviolet curable ink 61 to the ultraviolet light 67 from the ultraviolet irradiation device 63 (FIG. 11). The light-blocking film forming device 60 repeats the same formation step as that of the first light-blocking film 85, and laminates the second light-blocking film 86 on top of the first light-blocking film 85. The first light-blocking film 85 and the second light-blocking film 86 are sufficiently cured by the ultraviolet light 67 emitted from the ultraviolet irradiation device 63.

After forming the first light-blocking film 85 and the second light-blocking film 86, the substrate 81 is reversed (turned over), and the third light-blocking film 87 and the fourth light-blocking film 88 at the second lenses 83 side are formed with the same formation steps as that of the first light-blocking film 85 and the second light-blocking film 86. The third light-blocking film 87 and the fourth light-blocking film 88 are sufficiently cured by the ultraviolet light 67 from the ultraviolet irradiation device 63.

In the formation of the first to the fourth light-blocking films 85-88 of the lens array 80, the first and the second light-blocking films 85 and 86 on the side of the first lenses 82 having the wider opening width α may be formed first, or the third and the fourth light-blocking films 87 and 88 on the side of the second lenses 83 having the narrower opening width β may be formed first.

For the first to the fourth light-blocking films 85-88 of the lens array 80, when forming in advance the first and the second light-blocking films 85 and 86 on the side of the first lenses 82 having the wider base dimension u, the amount of the ultraviolet light that passes through the first lenses 82 having the wider base dimension u becomes significant. Thus, when forming the third light-blocking film 87, a portion of the ultraviolet light 67 from above the substrate 81 may be blocked by the first and the second light-blocking films 85 and 86. However, the third light-blocking film 87 may be cured by irradiating ultraviolet light also from a transparent conveyor bed during the formation of the third light-blocking film 87 on the side of the second lenses 83 having the narrower base dimension β. Accordingly, sufficient ultraviolet light can be irradiated on the third light-blocking film 87 formed after the first and the second light-blocking films 85 and 86 with ultraviolet light from the inside of the substrate 81, enabling it to sufficiently cure the third light-blocking film 87.

When the third and the fourth light-blocking film 87 and 88 on the side of the second lenses 83 having the narrower base dimension β are formed first, there is a great amount of reflection reflected at the first light-blocking film 85 from the third light-blocking film 87 by the ultraviolet light 67 during cure that is incident from the first lenses 82, during the formation of the first light-blocking film 85 at the first lenses 82 having the wider opening width. Accordingly, sufficient ultraviolet light can be irradiated to the first light-blocking film 85 formed later also from the inside of the substrate 81, and the first light-blocking film 85 can be sufficiently cured.

According to the second embodiment, the second light-blocking film 86 is laminated after forming the first light-blocking film 85 between the plurality of the first lenses 82 of the substrate 81, and the fourth light-blocking film 88 is laminated after forming the third light-blocking film 87 between the plurality of the second lenses 83 of the substrate 81. Since it is possible to make thinner the film thickness of the light-blocking film formed at a single formation step, the ultraviolet light 67 can sufficiently irradiate the ultraviolet curable ink 61, and the ultraviolet curable ink 61 can be cured in a reliable manner. The lens array 80 is equipped with light-blocking films having 24 μm total film thickness for both the first light-blocking film 85 having 12 μm in film thickness and the second light-blocking film 86 having 12 μm film thickness, at the first lenses 82 side. And at the second lenses 83 side, the lens array is equipped with light-blocking films having 24 μm total film thickness for both the third light-blocking film 87 having 12 μm film thickness and the fourth light-blocking film 88 having 12 μm in film thickness. In this way, superior light blocking properties can be achieved, enabling it to reliably block stray light, and a high quality lens can be obtained.

### Third Embodiment

Next, a third embodiment will be explained. In the third embodiment, the lens array is equipped with a plurality of lenses on both major surfaces of the substrate, and the lenses have different curvatures at each surface. In the third embodiment, the same components as described in the first embodiment will be given the same reference numerals and a detailed explanation of the components will be omitted for brevity.

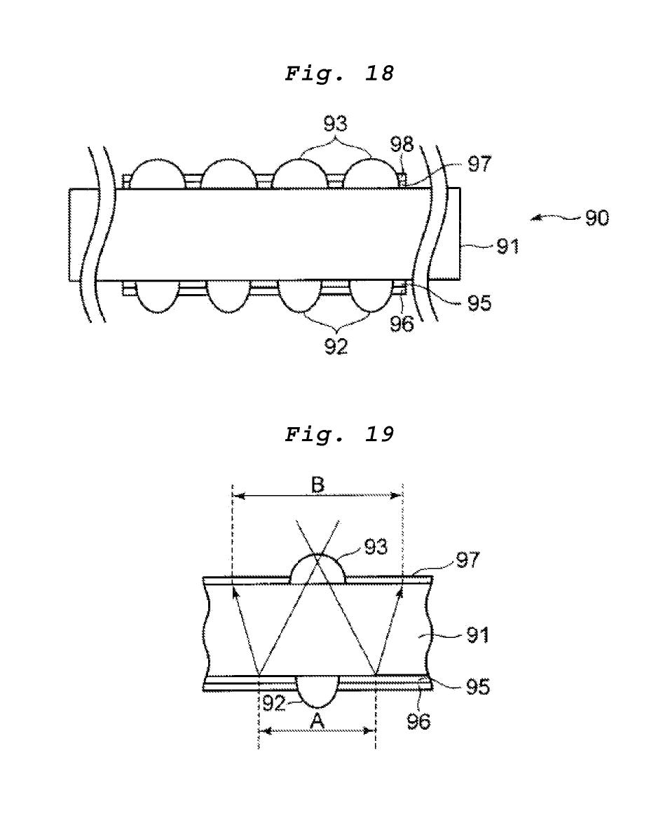

A lens array 90 according to the third embodiment as shown in FIG. 17 to FIG. 19 is provided with a plurality of first lenses 92, each having a first radius of curvature γ, and a plurality of second lenses 93, each having a second radius of curvature δ, on both major surfaces of a transparent substrate 91. The first radius of curvature γ of the first lenses 92 is smaller than the second radius of curvature δ of the second lenses 93. A first light-blocking film 95 and a second light-blocking film 96, each having 12 μm in thickness, are laminated between the plurality of the first lenses 92 of the lens array 90. The total film thickness for both the first light-blocking film 95 and the second light-blocking film 96 will become 24 μm after curing. A third light-blocking film 97 and a fourth light-blocking film 98, each having 12 μm in thickness, are laminated between the plurality of the second lenses 93 of the lens array 90. The total film thickness for both the third light-blocking film 97 and the fourth light-blocking film 98 will become 24 μm after curing. The first to the fourth light-blocking films 95-98 are formed by using the ultraviolet curable ink 61 having the same characteristics in which the content of carbon black is set at 3.5 wt %.

For the lens array 90, for example, the first light-blocking film 95 and the second light-blocking film 96 of the first lenses 92 having the smaller radius of curvature are formed first (using a process similar to the process described in FIGS. 9-11). The light-blocking film forming device 60 forms the first light-blocking film 95 by discharging the ultraviolet curable ink 61 in the amount so that the film thickness of the first light-blocking film 95 after curing becomes 12 μm, between the plurality of the first lenses 92. The first light-blocking film 95 is then cured by the ultraviolet light 67 from the ultraviolet irradiation device 63. The light-blocking film forming device 60 repeats the same step as the step of forming the first light-blocking film 95, and laminates the second light-blocking film 96 on top of the first light-blocking film 95. The first light-blocking film 95 and the second light-blocking film 96 are sufficiently cured by the ultraviolet light 67 from the ultraviolet irradiation device 63.

After forming the first light-blocking film 95 and the second light-blocking film 96, the substrate 91 is reversed, and the third light-blocking film 97 and the fourth light-blocking film 98 at the second lenses 93 are formed by the same formation steps as that of the first light-blocking film 95 and the second light-blocking film 96. The third light-blocking film 97 and the fourth light-blocking film 98 are sufficiently cured by the ultraviolet light 67 from the ultraviolet irradiation device 63.

In forming the first to the fourth light-blocking films 95-98 of the lens array 90, the first and the second light-blocking films 95 and 96 of the first lenses 92 having smaller radius of curvature may be formed first, or the third and the fourth light-blocking films 97 and 98 of the second lenses 93 having larger radius of curvature may be formed first.

When the first and the second light-blocking films 95 and 96 of the first lenses 92 having smaller radius of curvature are formed first, then during the formation of the third light-blocking film 97 of the second lenses 93 having larger radius of curvature, the ultraviolet light 67 incident from the second lenses 93 have a long focal length due to large radius of curvature as shown by width A in FIG. 19. Therefore, the ultraviolet light is dispersed on a wide region within the substrate 91, such as within the widened reflection area B by reflection off the first light-blocking film 95. Therefore, sufficient ultraviolet light can be irradiated from above the substrate 91 as well as from inside the substrate 91 over the entire length of the third light-blocking film 97 formed after the first and the second light-blocking films 95 and 96. Thus, the third light-blocking film 97 is sufficiently cured.

According to the third embodiment, the second light-blocking film 96 is laminated after forming the first light-blocking film 95 between the plurality of the first lenses 92 of the substrate 91, and the fourth light-blocking film 98 is laminated after forming the third light-blocking film 97 between the plurality of the second lenses 93 of the substrate 91. The film thickness of the light-blocking film formed by a single formation step can be made thinner, so in each formation step, the ultraviolet light 67 can be sufficiently irradiated to the ultraviolet curable ink 61 to ensure curing of the ultraviolet curable ink 61. The lens array 90 can be provided with the light-blocking films that have 24 μm in total film thickness in between either the first lenses 92 or the second lenses 93, so superior light blocking properties can be obtained. The light blocking films ensure blocking of stray light, and a high quality lens can be obtained.

### Fourth Embodiment

Next, a fourth embodiment will be explained. In the fourth embodiment, the lens array is equipped with a plurality of lenses on both major sides of the substrate, and the light-blocking films on each surface of the lens array have different thicknesses. In the fourth embodiment, the same components described in the first embodiment and the alternative example of the first embodiment will be given the same reference numerals and a detailed explanation will be omitted for brevity.

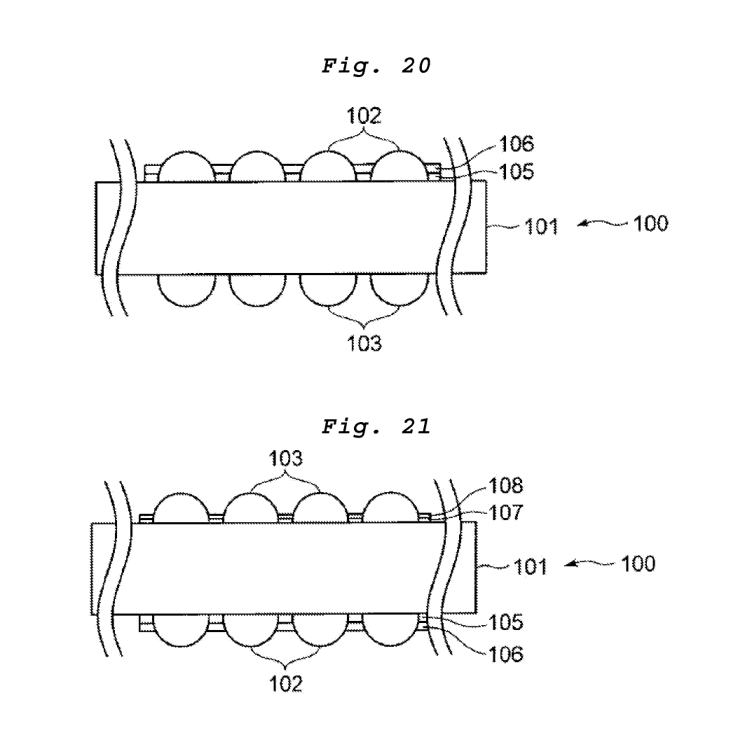

A lens array 100 of the fourth embodiment, as shown in FIG. 20 and FIG. 21, is equipped with a plurality of first lenses 102 and a plurality of second lenses 103 on both major sides of a transparent substrate 101. The first lenses 102 and the second lenses 103 have the same shape. Laminated between the plurality of the first lenses 102 of the lens array 100 are a first light-blocking film 105 and a second light-blocking film 106 having 12 μm in thickness, each of which includes the ultraviolet curable ink 61 having a 3.5 wt % carbon black content. The total film thickness for both the first light-blocking film 105 and the second light-blocking film 106 is 24 μm. Laminated between the plurality of the second lenses 103 of the lens array 100 are a third light-blocking film 107 and a fourth light-blocking film 108 having 6 m in thickness, each of which includes the ultraviolet curable ink 76 having a 7.5 wt % carbon black content. The total film thickness for both the third light-blocking film 107 and the fourth light-blocking film 108 is 12 μm.

For the lens array 100, the first light-blocking film 105 and the second light-blocking film 106 at the first lenses 102 are formed first (using a process similar to the process described in FIGS. 9-11). The light-blocking film forming device 60 forms the first light-blocking film 105 by discharging, between a plurality of the first lenses 102 from the inkjet printing unit 62, the ultraviolet curable ink 61 in an amount so that the film thickness of the first light-blocking film 105 after curing becomes 12 μm. The ultraviolet curable ink 61 is then cured by the ultraviolet light 67 from the ultraviolet irradiation device 63. The light-blocking film forming device 60 repeats the same step as the step of forming the first light-blocking film 105, and laminates the second light-blocking film 106 on top of the first light-blocking film 105. The first light-blocking film 105 and the second light-blocking film 106 are sufficiently cured by the ultraviolet light 67 from the ultraviolet irradiation device 63.

After forming the first light-blocking film 105 and the second light-blocking film 106, the substrate 101 is reversed, and the third light-blocking film 107 and the fourth light-blocking film 108 at the second lenses 103 are formed (using a process similar to the process described in FIGS. 9-11). The light-blocking film forming device 60 forms the third light-blocking film 107 by discharging, between a plurality of the second lenses 103 from the inkjet printing unit 62, the ultraviolet curable ink 76 (FIG. 14) in an amount so that the film thickness of the third light-blocking film 107 after curing becomes 6 μm, and curing the ultraviolet curable ink 76 by the ultraviolet light 67 from the ultraviolet irradiation device 63. The light-blocking film forming device 60 repeats the same step as the step of forming the third light-blocking film 107, and laminates the fourth light-blocking film 108 on top of the third light-blocking film 107. The third light-blocking film 107 and the fourth light-blocking film 108 are sufficiently cured by the ultraviolet light 67 from the ultraviolet irradiation device 63.

In the formation of the first to the fourth light-blocking films 105-108 of the lens array 100, the first and the second light-blocking films 105 and 106 at the first lenses 102 may be formed first, or the third and the fourth light-blocking films 107 and 108 at the second lenses 103 may be formed first.

According the fourth embodiment, the first light-blocking film 105 and the second light-blocking film 106 having 24 μm in total film thickness are laminated between the plurality of the first lenses 102 of the substrate 101, and the third light-blocking film 107 and the fourth light-blocking film 108 having 12 μm in total film thickness are laminated between the plurality of the second lenses 103 of the substrate 101. The film thickness of the light-blocking films formed can be made thin in a single formation step, so in each formation step of the first and the second light-blocking films 105 and 106, the ultraviolet light 67 can sufficiently irradiate the ultraviolet curable ink 61, and the ultraviolet curable ink 61 can be cured in a reliable manner. Similarly, in each formation step of the third and the fourth light-blocking films 107 and 108, the ultraviolet light 67 can sufficiently irradiate the ultraviolet curable ink 76, and the ultraviolet curable ink 76 can be cured in a reliable manner. The lens array 100 is equipped with, on the side of the first lenses 102, light-blocking films having 24 μm in total film thickness. The first and the second light-blocking films 105 and 106 are formed using the ultraviolet curable ink 61 having a 3.5 wt % carbon black content. The lens array 100 is also equipped with, on the side of the second lenses 103, light-blocking films having 12 μm in total film thickness, of which are formed using the ultraviolet curable ink 76 having 7.5 wt % in carbon black content. By doing so, superior light blocking properties can be obtained, enabling the lens array 100 to ensure blocking of stray light, and a high quality lens can be obtained.

According to at least one embodiment described above, provided between the plurality of lenses of the lens array are light-blocking films with a plurality of layers prepared by dividing the application of ultraviolet curable ink into multiple applications, followed by curing. Since the film thickness of the light-blocking film formed in a single step is thinner, in each formation step, the ultraviolet light can sufficiently irradiate the ultraviolet curable ink and the ultraviolet curable ink can be cured in a reliable manner. The lens array has superior light blocking properties with the final total of the light-blocking films having a plurality of layers.

This disclosure is not limited to the embodiments described above and various modifications are possible. For example, the shape, or the like, of the array of the plurality of lenses is arbitrary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lens array, comprising:
a plurality of lenses formed on a substrate, and
a light-blocking film formed between each of the plurality of lenses, the light-blocking film comprising a plurality of layers of an ultraviolet curable ink.

2. The lens array according to claim 1, wherein
the same ultraviolet curable ink is used to form each of the plurality of layers.

3. The lens array according to claim 2, wherein
a thickness of each of the individual layers of the plurality of layers is different.

4. The lens array according to claim 1, wherein
one of the plurality of layers comprises an ultraviolet curable ink having a light blocking characteristic that is different than a light blocking characteristic of the other layers.

5. The lens array according to claim 4, wherein a first layer of the plurality of layers includes a greater concentration of carbon black than a second layer of the plurality of layers.

6. The lens array according to claim 5, wherein
a thickness of the individual layers of the plurality of layers is different.

7. The lens array according to claim 1, wherein
the plurality of lenses comprises a first plurality of lenses formed on a first surface of the substrate, and
a second plurality of lenses formed on a second surface of the substrate.

8. The lens array according to claim 7, wherein
the same ultraviolet curable ink is used to form each of the plurality of layers.

9. The lens array according to claim 8, wherein
a thickness of the plurality of layers varies.

10. The lens array according to claim 7, wherein
one of the plurality of layers comprises an ultraviolet curable ink having a light blocking characteristic that is different than a light blocking characteristic of the other layers.

11. The lens array according to claim 10, wherein
a thickness of the plurality of layers varies.

12. An image forming device, comprising:
a scan device having a light source that emits light through a lens array, the lens array comprising:
a plurality of lenses formed on a substrate, and
a light-blocking film formed between each of the plurality of lenses, the light-blocking film comprising a plurality of layers of an ultraviolet curable ink.

13. The image forming device according to claim 12, wherein
the same ultraviolet curable ink is used to form each of the plurality of layers.

14. The image forming device according to claim 13, wherein
a thickness of the individual layers of the plurality of layers is different.

15. The image forming device according to claim 12, wherein
one of the plurality of layers comprises an ultraviolet curable ink having a light blocking characteristic that is different than a light blocking characteristic of the other layers.

16. The lens array according to claim 15, wherein a first layer of the plurality of layers includes a greater concentration of carbon black than a second layer of the plurality of layers.

17. The lens array according to claim 16, wherein
a thickness of the plurality of layers varies.

18. A method for manufacturing a lens array, comprising:
depositing a first ultraviolet curable ink between a plurality of lenses on a substrate;
curing the first ultraviolet curable ink to form a first layer;
depositing a second ultraviolet curable ink on the first layer; and
curing the second ultraviolet curable ink to form a second layer.

19. The method according to claim 18, wherein
the first ultraviolet curable ink is the same as the second ultraviolet curable ink.

20. The method according to claim 18, wherein
the first ultraviolet curable ink comprises a different light-blocking characteristic than the second ultraviolet curable ink.
